(19) United States
(12) Patent Application Publication
(10) Pub. No.: US 2019/0063117 A1
(43) Pub. Date: Feb. 28, 2019

(54) SPRING ASSISTED ACTUATOR FOR POWER RELEASE AND/OR CINCHING FUNCTIONALITY

(71) Applicant: Magna Closures Inc., Newmarket (CA)

(72) Inventor: Ann-Margaret MOZOLA, Lakefield (CA)

(21) Appl. No.: 16/106,295

(22) Filed: Aug. 21, 2018

Related U.S. Application Data
(60) Provisional application No. 62/550,802, filed on Aug. 28, 2017.

(51) Int. Cl. E05B 81/22; E05B 81/70; E05B 81/74; E05B 81/68

(52) U.S. Cl. CPC E05B 81/22; E05B 81/70; E05F 15/614; E05B 81/68; E05B 81/74

(57) ABSTRACT

A closure latch assembly equipped with a power-operated actuator having a spring-assist mechanism and which is applicable for providing power release and/or power cinching functionality.

### CROSS-REFERENCE TO RELATED APPLICATIONS

This application claims the benefit of U.S. Provisional Patent Application No. 62/550,802 filed on Aug. 28, 2017 and titled “SPRING ASSISTED ACTUATOR FOR POWER RELEASE AND/OR CINCHING FUNCTIONALITY”, the entire disclosure of which is hereby incorporated by reference.

### FIELD

The present disclosure relates generally to closure latch assemblies for use with a closure panel in motor vehicle closure systems. More particularly, the present disclosure is directed to a power-operated actuator for a closure latch assembly equipped with a spring-assist mechanism and which is applicable for providing power release and/or powered closure panel movement and/or power cinch functionality.

### BACKGROUND

This section provides background information related to closure latch assemblies of the type used in motor vehicle closure systems which is not necessarily prior art to the inventive concepts associated with the present disclosure.

In view of consumer demand for motor vehicles equipped with advanced comfort and convenience features, many modern vehicles are now provided with a passive keyless entry system to permit locking, unlocking and release of closure panels (i.e. passenger doors, tailgates, liftgates, decklids, etc.) without the use of a traditional key-type entry system. Some of the most popular features now available in association with closure systems include power locking/unlocking, power release and power cinching. These “powered” features are provided by a closure latch assembly mounted to the closure panel and equipped with a latch mechanism, a power-operated latch release mechanism and/or a power-operated latch cinch mechanism. Typically, the latch mechanism includes a ratchet and pawl arrangement configured to hold the closure panel in a closed position by virtue of the ratchet being held in a striker capture position to releasably engage and retain a striker that is mounted to a structural portion of the vehicle. The ratchet is held in its striker capture position by the pawl mechanically engaging the ratchet in a ratchet holding position. In many closure latch assemblies, the latch mechanism is configured such that the pawl is operable in its ratchet holding position to mechanically engage and retain the ratchet in at least two distinct striker capture positions, namely a secondary (i.e. “soft close”) striker capture position and a primary (i.e. “hard close”) striker capture position.

In closure latch assemblies providing a power release feature, a power release actuator is selectively actuated to cause the latch release mechanism to move the pawl from its ratchet holding position into a ratchet releasing position, whereby a ratchet biasing arrangement is permitted to forcibly pivot the ratchet from its striker capture position(s) into a striker release position for releasing the striker and allowing movement of the closure panel from its closed position to an open position. In closure latch assemblies providing a power cinching feature, a power cinch actuator is selectively actuated to cause the latch cinch mechanism to pivot the ratchet from its secondary striker capture position into its primary striker capture position, while the pawl is maintained in its ratchet holding position, thereby cinching the closure panel from a partially-closed position into a fully-closed position. A common electric actuator, or separate electric actuators, can be associated with the power release and power cinching features. However, the power release feature is typically independent from the power cinching feature.

In many closure latch assemblies providing a power release feature, the latch release mechanism is normally maintained in a non-actuated state and is only shifted into an actuated state when sensors indicate a door release operation has been requested and authenticated by the passive keyless entry system (i.e. via actuation of a key fob or a handle-mounted switch). Actuation of the power release actuator is required for shifting the latch release mechanism from its non-actuated state into its actuated state. Following completion of the power release operation, when the sensors indicate that the ratchet is located in its striker release position, the latch release mechanism must be “reset”, that is returned to its non-actuated state, to permit subsequent latching of the latch mechanism upon movement of the closure panel toward its closed position(s).

In closure latch assemblies providing a power cinching feature, the latch cinch mechanism is normally maintained in a non-actuated state and is only shifted into an actuated state when sensors indicate that the ratchet is located in its secondary striker capture position. Actuation of the power cinch actuator is required for shifting the latch cinch mechanism from its non-actuated state into its actuated state. Following completion of the power cinching operation, when the sensors indicate that the ratchet is located in its primary striker capture position, the latch cinch mechanism must be “reset”, that is returned to its non-actuated state, to permit subsequent uninhibited movement of the ratchet to its striker release position via actuation of the latch release mechanism. As is understood, if the closure panel is initially closed with sufficient closing force to locate the ratchet in its primary striker capture position, then the power cinching operation is bypassed and the latch cinch mechanism is maintained in its non-actuated state.

In many closure latch assemblies providing a power release feature and/or a power cinching feature, the power-operated actuator includes a reverse-drivable electric motor and gear reduction unit configured to be driven in a first direction to actuate the latch release mechanism and/or the latch cinch mechanism and in a second direction to reset the corresponding mechanisms. In power release configurations, the power release actuator requires an electric motor sized to provide an actuation or “latch opening” force capable of overcoming the frictional forces between the ratchet and pawl, typically due to the seal forces exerted between the striker and the ratchet, for moving the pawl to its ratchet releasing position. In power cinching configurations, the power cinch actuator requires an electric motor sized to provide an actuation or “latch cinching” force cable of pivoting the ratchet from its secondary striker capture position into its primary striker capture position in opposition to the biasing exerted on the ratchet by the ratchet biasing arrangement. In both power configurations, the force requirements associated with the electric motors to reset (i.e., the “reset force”) the latch release mechanism and/or latch cinch mechanism is significantly less than the actuation force.

While current power-operated closure latch assemblies are sufficient to comply with all regulatory requirements and provide enhanced comfort and convenience features, a need still exists to advance the technology and provide alternative power-operated actuators and mechanisms that address and overcome at least some of the known shortcomings associated with conventional closure latch assemblies.

### SUMMARY

This section provides a general summary of the disclosure, and is not intended to be considered an exhaustive and comprehensive listing of all of the features, aspects, advantages and objectives associated with the inventive concepts described and illustrated in the detailed description and drawings provided herein.

It is an aspect of the present disclosure to provide a closure latch assembly for a closure panel of a motor vehicle closure system and which is configured to provide at least one of a power release feature and a power cinching feature equipped with a power actuator providing a spring-assisted actuation function.

It is a related aspect to provide the closure latch assembly with a latch mechanism and a power release actuator configured to include a latch release mechanism, an electric motor, a gear reduction mechanism, a spring-assist mechanism and an interlock mechanism. The latch mechanism is operable in a latched state to hold the closure panel in a closed position and in an unlatched state to permit movement of the closure panel to an open position. The latch release mechanism is operable in a non-actuated state to permit the latch mechanism to be maintained in its latched state and in an actuated state to shift the latch mechanism from its latched state into its unlatched state. The electric motor and the gear reduction mechanism can be driven in a first or “actuation” direction for shifting the latch release mechanism from its non-actuated state into its actuated state and can be driven in a second or “reset” direction for returning the latch release mechanism to its non-actuated state. The spring-assist mechanism is operable in a spring-loaded state when the latch release mechanism is operating in its non-actuated state and is shifted into a spring-released state when the latch release mechanism is shifted into its actuated state for exerting an assist force on the latch release mechanism that is operable to assist in shifting the latch mechanism into its unlatched state. The interlock mechanism is operable in a locked state to maintain the spring-assist mechanism in its spring-loaded state and is operable in a released state to shift the spring-assist mechanism into its spring-released state.

To provide a “power release” feature, the electric motor and gear reduction mechanism of the power release actuator are driven in the actuation direction for causing the latch release mechanism to shift into its actuated state and to cause the interlock mechanism to shift into its release state, whereby the spring-assist mechanism is shifted into its spring-released state to assist the latch release mechanism in shifting the latch mechanism into its unlatched state. Upon completion of the power release operation, the electric motor and the gear reduction mechanism are driven in the reset direction for returning the latch release mechanism to its non-actuated state, returning the spring-assist mechanism to its spring-loaded state, and shifting the interlock mechanism back into its locked state.

It is another related aspect to provide the closure latch assembly with a latch mechanism and a power cinch actuator configured to include a latch cinch mechanism, an electric motor, a gear reduction mechanism, a spring-assist mechanism, and an interlock mechanism. The latch mechanism is operable in a secondary latched state when the closure panel is held in a partially-closed position and in a primary latched state when the closure panel is held in a fully-closed position. The latch cinch mechanism is operable in a non-actuated mode when the latch mechanism is in its primary latched state and in an actuated state to shift the latch mechanism from its secondary latched state into its primary latched state. The electric motor and the gear reduction mechanism can be driven in a first or “actuation” direction for shifting the latch cinch mechanism into its actuated state and can be driven in a second or “reset” direction for returning the latch cinch mechanism to its non-actuated state. The spring-assist mechanism is operable in a spring-loaded state when the latch cinch mechanism is operating in its non-actuated state and is shifted into a spring-released state when the latch cinch mechanism is shifted into its actuated state for exerting an assist force on the latch cinch mechanism operable to assist in shifting the latch mechanism from its secondary latched state into its primary latched state. The interlock mechanism is operable in a locked state to maintain the spring-assist mechanism in its spring-loaded state and is operable in a released state to shift the spring-assist mechanism into its spring-released state.

To provide a “power cinching” feature, the electric motor and the gear reduction mechanism of the power cinch actuator are driven in the actuation direction to shift the latch cinch mechanism into its actuated state and to cause the interlock mechanism to shift into its released state, whereby the spring-assist mechanism is shifted into its spring-released state to assist the latch cinch mechanism in shifting the latch mechanism from its secondary latched state into its primary latched state. Upon completion of the power cinching operation, the electric motor and the gear reduction mechanism are driven in the reset direction for returning the latch cinch mechanism to its non-actuated state, returning the spring-assist mechanism to its spring-loaded state, and shifting the interlock mechanism back into its locked state.

It is yet another related aspect to provide the closure latch assembly with a latch mechanism and a power-operated actuator configured to include an actuatable mechanism, an electric motor, a gear reduction mechanism, a spring-assist mechanism, and an interlock mechanism. The latch mechanism is operable in a first state to hold the closure panel in a first position and in a second state to locate the closure panel to a second position. The actuatable mechanism is normally operable in a non-actuated state and can be shifted into an actuated state to shift the latch mechanism from its first state into its second state. The electric motor and the gear reduction mechanism can be driven in a first rotary direction for shifting the actuatable mechanism from its non-actuated state into its actuated state and can be driven in a second rotary direction for resetting the actuatable mechanism in its non-actuated state. The spring-assist mechanism is operable in a spring-loaded state when the actuatable mechanism is operating in its non-actuated state and is shifted into a spring-released state when the actuatable mechanism is shifted into its actuated state for exerting a spring force on the actuatable mechanism for assisting in shifting the latch mechanism from its first state into its second state. The interlock mechanism is operable in a locked state to hold the spring-assist mechanism in its spring-loaded state and is operable in a released state to release the spring-assist mechanism to permit the spring-assist mechanism to shift into its spring-released state.

In accordance with a first embodiment, the actuatable mechanism is a latch release mechanism operable in its non-actuated state to permit the latch mechanism to be maintained in either of its first or “latched” state and its second or “unlatched” state. The latch release mechanism is also operable in its actuated state to shift the latch mechanism from its latched state into its unlatched state. The latch mechanism is operable in its latched state to hold the closure panel in its first or “closed position” and is operable in its unlatched state to permit movement of the closure panel to its second or “open” position. The shifting of the spring-assist mechanism into its spring-released state results in the spring force being applied to the latch release mechanism for assisting in shifting of the latch mechanism from its latched state into its unlatched state. As such, a spring-assist function is provided to a power release type of closure latch assembly.

In accordance with a second embodiment, the actuatable mechanism is a latch cinch mechanism operable in its non-actuated state when the latch mechanism is operating in its first or “secondary latched” state for holding the closure panel in its first or “partially-closed” position. The latch cinch mechanism is also operable in its actuated state to shift the latch mechanism from its secondary latched state into its second or “primary latched” state for moving he closure panel to its second or “fully-closed” position. The shifting of the spring-assist mechanism into its spring-released state results in the spring force being applied to the latch cinch mechanism for assisting in shifting the latch mechanism from its secondary latched state into its primary latched state. As such, a spring-assist function is provided to a power cinching type of closure latch assembly.

In accordance with another embodiment, there is provided an actuator assembly, such as a door presenter, a powered spindle/actuator for a liftgate, a powered door actuator, and the like for a moving a closure panel of a motor vehicle between an open position and a closed position. The actuator assembly includes a power actuator including an actuatable mechanism moveable between a retracted position and a deployed position for imparting a motion of the closure panel between its open position and closed position, an electric motor for moving the actuatable mechanism between the deployed position and the retracted position, a spring-assist mechanism, and an interlock mechanism. The actuatable mechanism being operable in a non-actuated state to permit the closure panel to operate in its closed position and in an actuated state to shift the closure panel from its closed state into its open position, the electric motor being operably driven in an actuation direction for causing the actuatable mechanism to shift from its retracted position into its deployed state and being operably driven in a reset direction for causing the actuatable mechanism to shift from its deployed state into its retracted state, the spring-assist mechanism being operable in a spring-loaded state when the actuatable mechanism is operating in its retracted state and being operable in a spring-released state when the actuatable mechanism is shifted into its deployed state, the interlock mechanism being operable in a locked state to hold the spring-assist mechanism in its spring-loaded state and in a released state to cause the spring-assist mechanism to shift into its spring-released state, wherein the spring-assist mechanism is operable in its spring-released state to exert a spring-assist force on the actuatable mechanism which functions in cooperation with rotation of the electric motor in the actuation direction to drive the closure panel to its open state for providing a spring-assisted power opening function.

Further areas of applicability will become apparent from the detailed description provided herein when viewed in conjunction with the appended drawings. However, the specific examples and details provided in this summary are intended for purposes of disclosing non-limiting features without limiting the scope of the present disclosure.

### DRAWINGS

The drawings described herein are provided to illustrate selected, non-limiting embodiments without limiting the intended scope of protection afforded to the present disclosure.

FIG. 1 is a partial isometric view of a motor vehicle equipped with a closure panel having a closure latch assembly constructed and operable in accordance with the teachings of the present disclosure;

FIG. 2 is a plan view of the closure latch assembly shown in FIG. 1 equipped with a latch mechanism and a spring-assisted power release actuator configured to include a latch release mechanism, an electric motor, gear reduction mechanism, a spring-assist mechanism, and an interlock mechanism;

FIG. 3 is a partial plan view, similar to FIG. 2, but now showing the components associated with the spring-assist mechanism in greater detail;

FIGS. 4A through 4E are a series of sequential plan views showing a “power release” operation for the closure latch assembly of the present disclosure and which provides a spring-assisted actuation of the latch release mechanism; and

FIGS. 5A through 5C are a series of sequential plan views showing a “power reset” operation for the closure latch assembly of the present disclosure.

Corresponding reference numerals are used throughout the several drawings to identify corresponding components and mechanisms.

### DETAILED DESCRIPTION

An example embodiment will now be described more fully with reference to the accompanying drawings. To this end, the example embodiment is provided so that this disclosure will be thorough, and will fully convey its intended scope to those who are skilled in the art. Accordingly, numerous specific details are set forth such as examples of specific components, devices, and methods, to provide a thorough understanding of alternate embodiments of the present disclosure. However, it will be apparent to those skilled in the art that specific details need not be employed, that the example embodiment may be embodied in many different forms, and that neither should be construed to limit the scope of the present disclosure. In the example embodiment, well-known processes, well-known device structures, and well-known technologies are not described in detail.

In the following detailed description, the expression “closure latch assembly” will be used to generally indicate any power-operated latch device adapted for use with a vehicle closure panel to provide a power cinch feature and/or a power release feature. Additionally, the expression “closure panel” will be used to indicate any element moveable between an open position and at least one closed position, respectively opening and closing an access to an inner compartment of a motor vehicle and therefore includes, without limitations, decklids, tailgates, liftgates, bonnet lids, and sunroofs in addition to the sliding or pivoting side doors of the motor vehicle to which the following description will make explicit reference, purely by way of example.

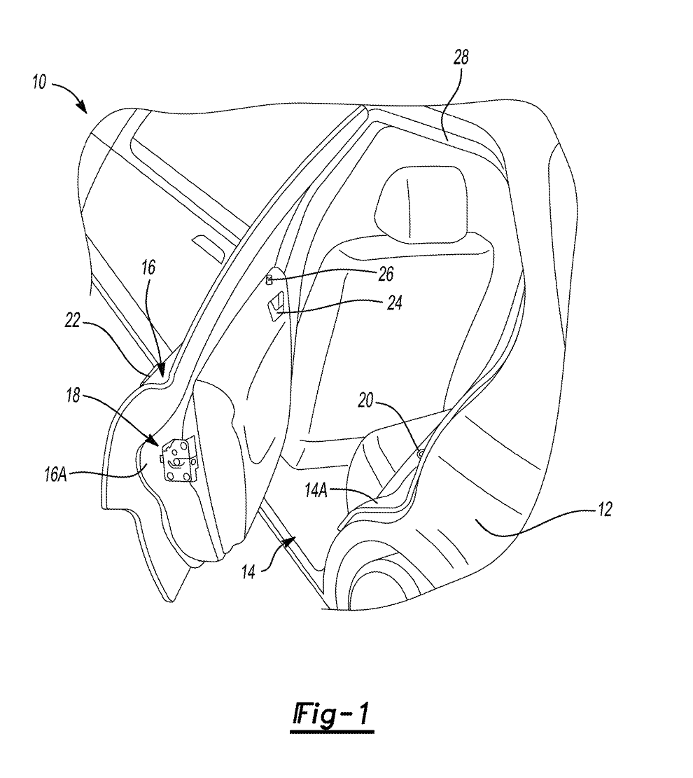

Referring initially to FIG. 1 of the drawings, a motor vehicle 10 is shown to include a vehicle body 12 defining an opening 14 to an interior passenger compartment. A closure panel 16 is pivotably mounted to body 12 for movement between an open position (shown) and a fully-closed position to respectively open and close opening 14. A closure latch assembly 18 is rigidly secured to closure panel 16 adjacent to an edge portion 16A thereof and is releasably engageable with a striker 20 that is fixedly secured to a recessed edge portion 14A of opening 14. As will be detailed, closure latch assembly 18 is operable to engage striker 20 and releaseably hold closure panel 16 into its fully-closed position. An outside handle 22 and an inside handle 24 are provided for actuating closure latch assembly 18 to release striker 20 and permit subsequent movement of closure panel 16 to its open position. An optional lock knob 26 is shown which provides a visual indication of the locked state of closure latch assembly 18 and which may also be operable to mechanically change the locked state of closure latch assembly 18. A weather seal 28 is mounted on edge portion 14A of opening 14 in vehicle body 12 and is adapted to be resiliently compressed upon engagement with a mating sealing surface of closure panel 16 when closure panel 16 is held by closure latch assembly 18 in its fully-closed position so as to provide a sealed interface therebetween which is configured to prevent entry of rain and dirt into the passenger compartment while minimizing audible wind noise. For purpose of clarity and functional association with motor vehicle 10, the closure panel is hereinafter referred to as passenger door 16.

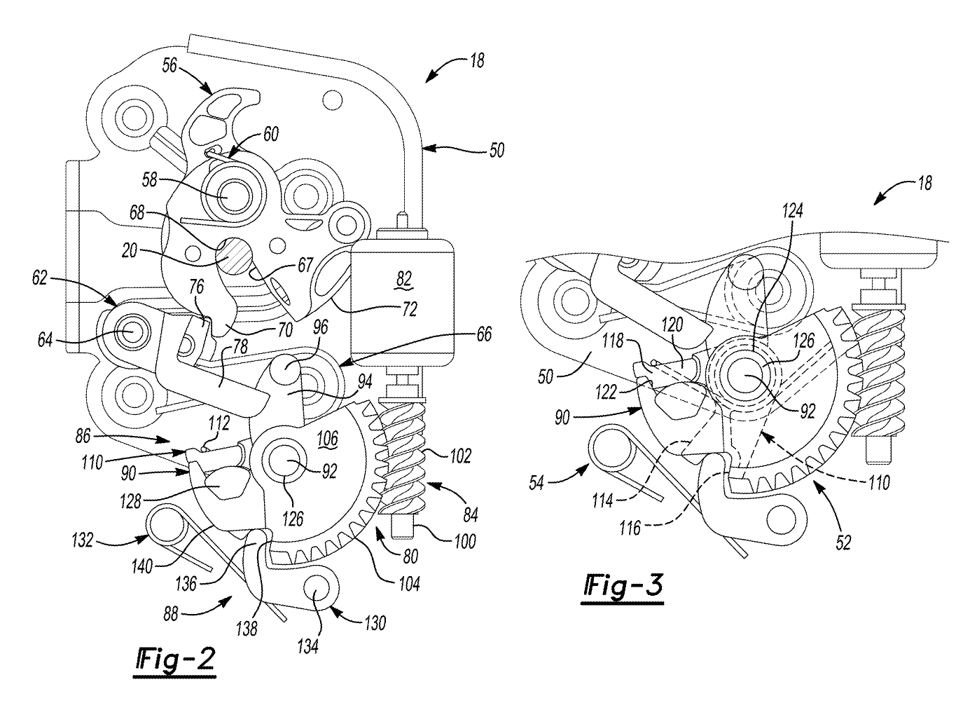

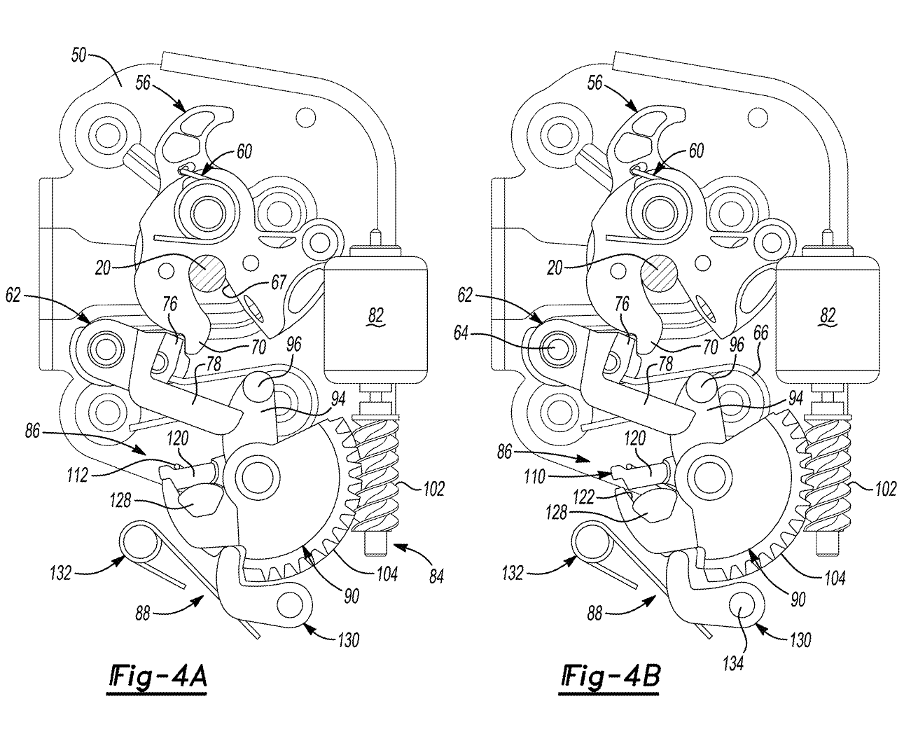

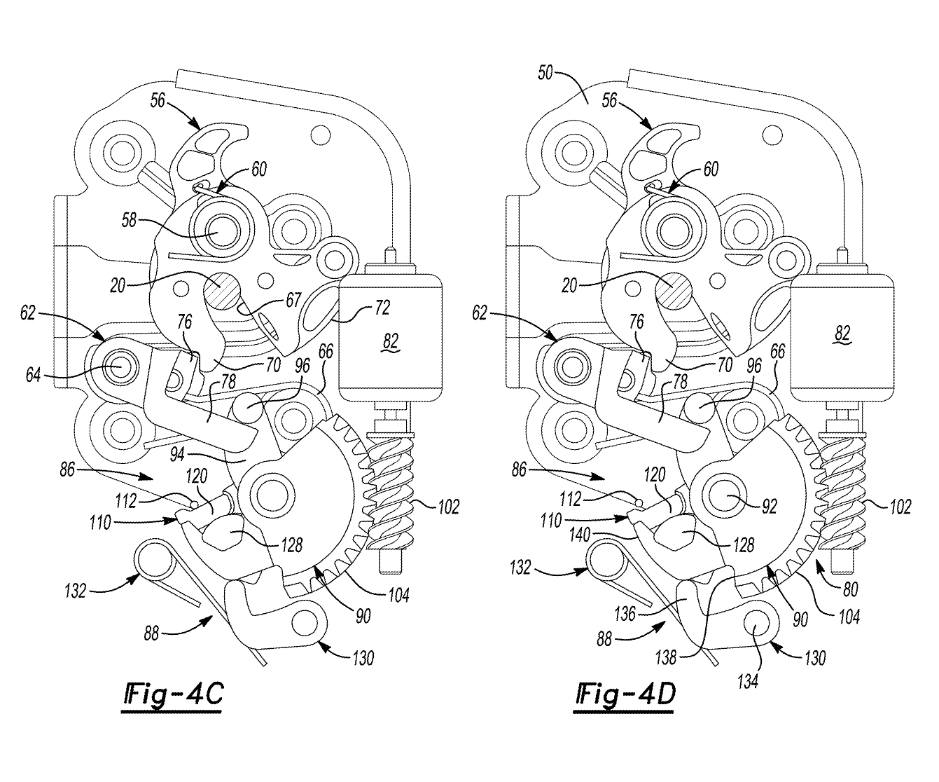

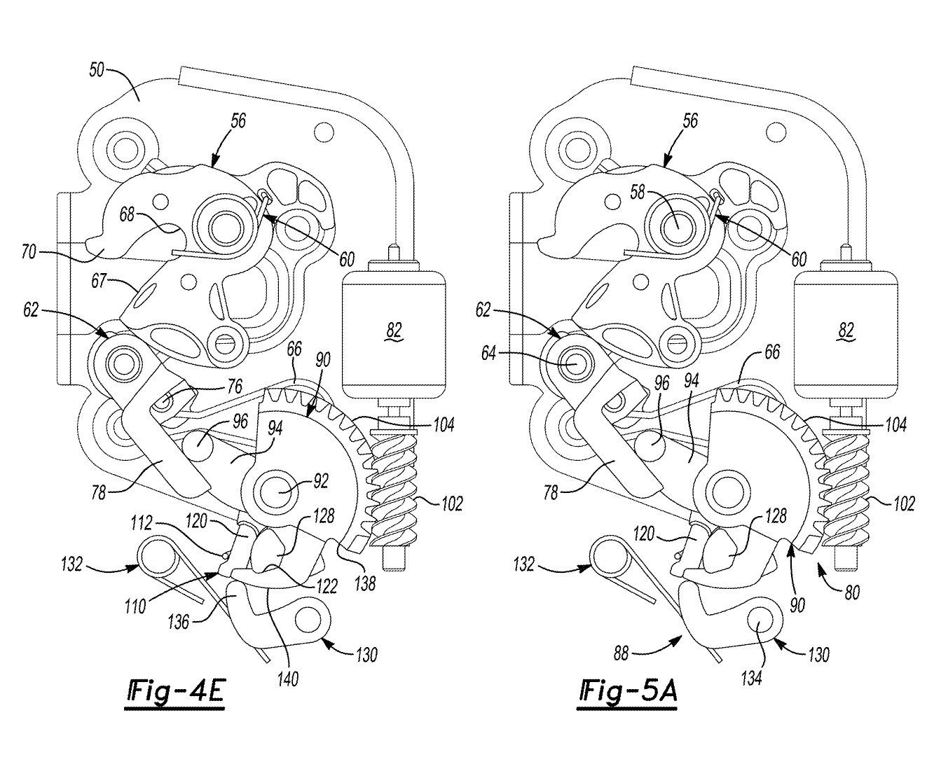

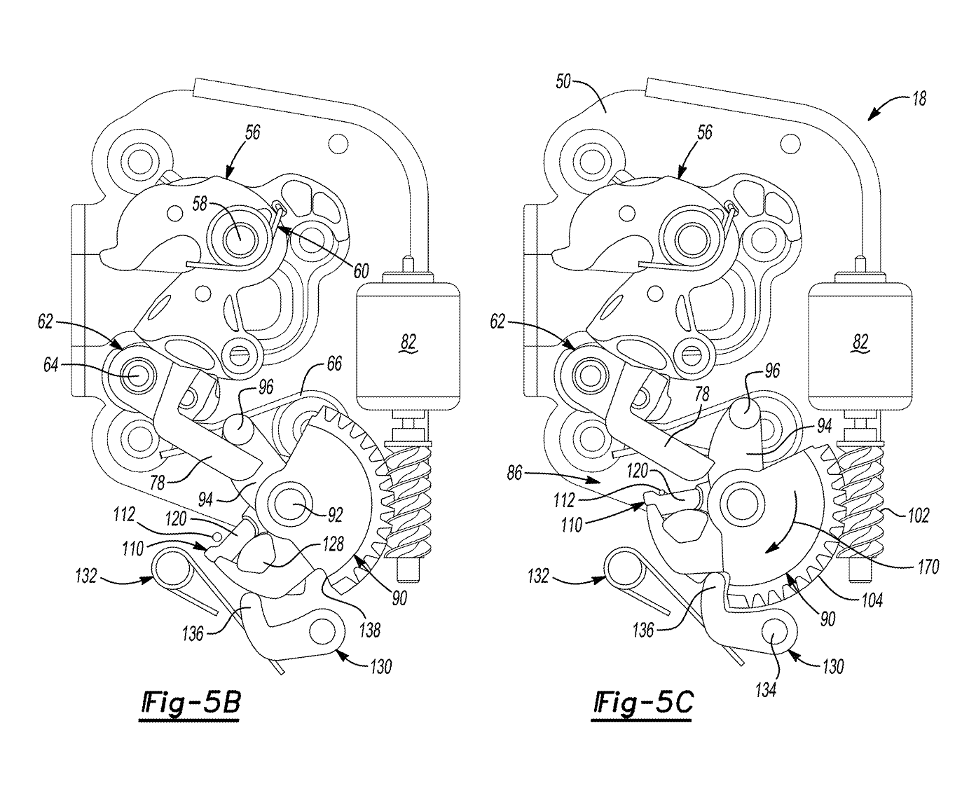

Referring now to FIGS. 2 through 5, a non-limiting example embodiment of closure latch assembly 18 will now be described. Generally speaking, closure latch assembly 18 includes a latch housing having a latch plate 50, a latch mechanism 52, and a spring-assisted power release actuator 54. Latch mechanism 52 includes a ratchet 56 supported for pivotal movement relative to latch plate 50 about a ratchet rivet 58, a ratchet spring 60, a pawl 62 supported for pivotal movement relative to latch plate 50 about a pawl pivot 64, and a pawl spring 66. Ratchet 56 is configured to include a striker guide slot 67 which terminates in a striker capture cavity 68, a latch notch 70, and a cam edge surface 72. Ratchet 56 is moveable between a striker release position (FIGS. 4E and 5A-5C) whereat striker 20 is released from striker capture cavity 68 (passenger door 16 is opened) and a striker capture position (FIGS. 2 and 4A-4D) whereat striker 20 is retained within striker capture cavity 68 (passenger door 16 is closed). Ratchet spring 60 is operably disposed between ratchet 56 and latch plate 50 for normally biasing ratchet 56 toward its strike release position. Pawl 62 is moveable between a ratchet releasing position (FIGS. 4E and 5A-5C) whereat its latch shoulder 76 is disengaged from latch notch 70 on ratchet 56 so as to permit ratchet spring 60 to forcibly move ratchet 56 to its striker release position, and a ratchet holding position (FIGS. 2 and 4A-4D) whereat latch shoulder 76 engages latch notch 70 so as to mechanically hold ratchet 56 in its striker capture position. Pawl spring 66 is operably disposed between pawl 62 and latch plate 50 for normally biasing pawl 62 toward its ratchet holding position. In addition to latch shoulder 76, pawl 62 is configured to include a latch release arm 78. Latch mechanism 52 is defined to operate in an unlatched state when ratchet 56 is located in its striker release position and to operate in a latched state when ratchet 56 is held in its striker capture position by pawl 62.

With continued reference to the drawings, spring-assisted power release actuator 54 is generally shown to include a latch release mechanism 80, an electric motor 82, a gear reduction mechanism 84, a spring-assist mechanism 86, and an interlock mechanism 88. Latch release mechanism 80 is shown, in this non-limiting embodiment, to include a release cam 90 supported for rotational movement on latch plate 50 about a release cam pivot 92 and which is configured to include an arm segment 94 having an upstanding pawl release lug 96. Release cam 90 is moveable between a home position (FIGS. 2, 3, 4A and 5C) whereat pawl release lug 96 is disengaged from latch release arm 78 on pawl 62 and a pawl release position (FIGS. 4E and 5A) whereat pawl release lug 96 has engaged latch release arm 78 on pawl 62 and caused pawl 62 to move to its ratchet releasing position. Movement of release cam 90 in a first or “actuation” direction (i.e. counterclockwise) from its home position into its pawl release position functions to provide a power release function and movement of release cam 90 in a second or “reset” direction (i.e. clockwise) from its power release position to its home position functions to provide a power reset function. Latch release mechanism 80 is defined to be operating in a non-actuated state when release cam 90 is located in its home position and to be operating in an actuated state when release cam 90 is located in its pawl release position.

Electric motor 82 is supported by the latch housing and includes a motor shaft 100. Gear reduction mechanism 84 includes a worm 102 fixed to motor shaft 100 and having threads meshed with gear teeth formed on a worm gear 104. In this non-limiting example, worm gear 104 is integrally formed on a gear segment 106 of release cam 90. Controlled actuation of electric motor 82 controls the direction of rotation of motor shaft 100 so as to permit rotation of release cam 90 between its home and pawl release positions. Thus, electric motor 82 and gear reduction mechanism 84 are configured to be driven in a first direction to rotate release cam 90 in its actuation direction and to be reverse-driven in a second direction to rotate release cam 90 in its reset direction.

Spring-assist mechanism 86 is best shown in FIG. 3 to include an assist lever 110 and an assist lever spring 112. Assist lever 110 includes an interlock leg segment 114 defining an interlock notch 116, a release cam leg segment 118 with an upstanding drive lug 120, and a tubular boss segment 124 interconnecting interlock leg segment 114 to release cam leg segment 118. Upstanding drive lug 120 on release cam leg segment 118 of assist lever 110 is shown retained within a drive lug retention cavity 122 formed in release cam 90. Boss segment 124 of assist lever 110 surrounds a tubular boss segment 126 formed on release cam 90 so as to be mounted for pivotal movement about the axis defined by release cam pivot 92. Assist lever spring 112 surrounds tubular boss segment 124 of assist lever 110 and has its opposite ends acting between latch plate 50 and assist lever 110 for normally biasing assist lever 110 toward a spring-released position, represented by arrow 171, whereat drive lug 120 engages a bumper 128 mounted in drive lug retention cavity 122 of release cam 90.

As will be detailed, assist lever 110 is moveable between a spring-loaded position (FIG. 3) when release cam 90 is located in its home position and its spring-released position (FIG. 4E) when release cam 90 is located in its pawl release position. Spring-assist mechanism 86 is defined as operating in a spring-loaded state when latch release mechanism 80 is operating in its non-actuated state. However, spring-assist mechanism 86 can be shifted from its spring-loaded state into a spring-released state when latch release mechanism 80 is shifted into its actuated state so as to cause assist lever spring 112 to exert a “spring assist” force on latch release mechanism 80. This spring assist force is operable to assist electric motor 82 and gear reduction mechanism 84 in shifting latch mechanism 52 from its latched state into its unlatched state during a power release operation by assisting in the rotation of release cam 90 from its home position to its pawl release position.

Interlock mechanism 88 generally includes an interlock lever 130 and an interlock lever spring 132. Interlock lever 130 is mounted to latch plate 50 for pivotal movement about an interlock lever pivot post 134 between a locked position (FIGS. 2 and 3) and a released position (FIGS. 4C-4E). Interlock lever spring 132 is operable to normally bias interlock lever 130 toward its locked position. Interlock lever 130 includes a latch tooth 136 configured to be retained in a release cam interlock notch 138 formed in release cam 90 when release cam 90 is located in its non-actuated position and interlock lever 130 is located in its locked position. Note that latch tooth 136 on interlock lever 130 is also located within interlock notch 116 on assist lever 110 to hold assist lever 110 in is spring-loaded position, for example by blocking engagement with notch surface 117 provided on the release cam interlock notch 138

Rotation of release cam 90 in the actuation direction from its home position toward its pawl release position causes latch tooth 136 on interlock lever 130 to exit release cam interlock notch 138, for example by driven movement of the latch tooth 136 by notch surface 119 illustratively forming a cam surface, and engage a raised cam edge 140 on release cam 90 for moving interlock lever 130 from its locked position to its released position in opposition to the biasing of interlock lever spring 132. As will be detailed, this action of moving interlock lever 130 into its released position also causes latch tooth 136 to disengage interlock notch 116 on assist lever 110, thereby permitting assist lever spring 112 to forcibly move assist lever 110 from its spring-loaded position to its spring-released position. As noted, release of assist lever 110 causes drive lug 120 to move into engagement with bumper 128 within drive lug retention cavity 122 and exert the biasing (i.e. the spring assist force) of assist lever spring 112 on release cam 90 for assisting in moving release cam 90 to its pawl release position. Specifically, with assist lever 110 released to move toward its spring-released position, the biasing of assist lever spring 112 exerts the spring assist force on release cam 90 which functions to assist in driving release cam 90 in its actuation direction toward its pawl release position. Interlock mechanism 88 is defined to be operating in a locked state when interlock lever 130 is located in its locked position for maintaining spring-assist mechanism 86 in its spring-loaded state and is further defined to be operating in a released state when interlock lever 130 is located in its release position to shift spring-assist mechanism 86 into its spring-released state.

Referring now to FIGS. 4A through 4E, the power release operation of closure latch assembly 18 is shown via a series of sequential plan views. FIG. 4A illustrates latch mechanism 52 operating in its latched state with ratchet 56 held in its striker capture position by pawl 62 located in its ratchet holding position. Spring-assisted power release actuator 54 is also shown with latch release mechanism 80 operating in its non-actuated state (release cam 90 located in its home position), spring-assist mechanism 86 operating in its spring-loaded state (assist lever 110 held by interlock lever 130 in its spring-loaded position), and interlock mechanism 88 operating in its locked state (interlock lever 130 located in its locked position). FIG. 4B illustrates initiation of the power release operation by electric motor 82 and gear reduction mechanism 84 causing release cam 90 to rotate in its actuation direction, as indicated by arrow 160. As seen in FIG. 4B, this initial rotating of release cam 90 causes latch tooth 136 on interlock lever 130 to move along the surface 117 of release cam interlock notch 138 in release cam 90 while continuing to hold assist lever 110 in its spring-loaded position.

FIG. 4C illustrates that electric motor 82 and gear reduction mechanism 84 continue to rotate release cam 90 in its actuation direction, which in turn, causes latch tooth 136 on interlock lever 130 to exit release cam interlock notch 138 and ride along raised cam edge 140 for moving interlock lever 130 to its released position. As seen in FIG. 4C, with interlock lever 130 held in its released position, its latch tooth 136 is also now released from interlock notch 116 on assist lever 110. As such, assist lever spring 112 is permitted to forcibly pivot assist lever 110 from its spring-loaded position into its spring-released position so as to cause drive lug 120 to engage bumper 128 and exert the spring assist force of assist lever spring 112 on release cam 90. This spring assist force provided by assist lever spring 112 works in cooperation with electric motor 82 and gear reduction mechanism 84 to forcibly drive release cam 90 toward its pawl release position. It is recognized that while assist lever spring 112 and interlock lever 130 act on assist lever 110 to assist the motor 82 to drive the release cam 90, the assist lever spring 112 and interlock lever 130 can act on other actuator components, such as latch components, forming part of the kinematic chain between an actuator, such as motor 82 and an actuatable mechanism, such as pawl 62. For example, assist lever spring 112 and interlock lever 130 can be applied to assist the assist lever 110 in the rotation of the motor shaft 100, upstream in the kinematic release chain of closure latch assembly 18. FIG. 4C also illustrates initial engagement of pawl release lug 96 on arm segment 94 of release cam 90 with latch release arm 78 of pawl 62 to initiate movement of pawl 62 from its ratchet holding position toward its ratchet releasing position. FIGS. 4D and 4E illustrate continued spring-assisted powered rotation of release cam 90 in the actuation direction, due to the release of the spring energy stored in assist lever spring 112 and the driven rotation of electric motor 82, until release cam 90 is finally located in its pawl release position. Thus, FIG. 4E illustrates latch mechanism 52 in is unlatched state with pawl 62 held in its ratchet releasing position and ratchet 56 located in its striker release position. At this point, electric power to motor 82 is interrupted and the power release operation is completed.

Referring now to FIGS. 5A through 5C, a power reset operation for closure latch assembly 18 is shown via a series of sequential plan views. FIG. 5A is generally identical to FIG. 4E and shows the location of the various components following completion of the power release operation and prior to initiation of the power reset operation. Specifically, latch mechanism 52 is operating in its unlatched state with pawl 62 located in its ratchet releasing position and ratchet 56 located in its striker release position. Spring-assisted power release actuator 54 is also shown with latch release mechanism 80 operating in its actuated state (release cam 90 located in its pawl release position), spring-assist mechanism 86 operating in its spring-released state (assist lever 110 moved to its spring-released position), and interlock mechanism 88 operating in its released state (interlock lever 130 held in its released position).

FIG. 5B illustrates initial rotation of release cam 90 in the reset direction via actuation of electric motor 82, as is indicated by arrow 170. This rotation of release cam 90 also causes movement of assist lever 110 toward its spring-loaded position due to continued engagement of drive lug 120 with release cam-mounted bumper 128, in opposition to the biasing of assist lever spring 112. Such rotation of release cam 90 also permits pawl spring 66 to pivot pawl 62 back toward its ratchet holding position. However, pawl latch shoulder 76 continues to engage cam edge surface 72 of ratchet 56 while ratchet 56 is located in its striker release position to prevent movement of pawl 62 toward its ratchet holding position.

FIG. 5C illustrates complete rotation of release cam 90 in the reset direction to its home position such that interlock lever 130 is located in its locked position with latch tooth 136 retained in release cam interlock notch 138 of release cam 90 and latch tooth 136 is also retained within interlock notch 116 of assist lever 110, thereby holding assist lever 110 in its spring-loaded position. Rotation of assist lever 110 from its spring-released position (FIG. 5A) into its spring-loaded position (FIG. 5C) functions to load and store energy in assist lever spring 112. Thus, latch release mechanism 80 is reset in its non-actuated state, spring-assist mechanism 86 is reset into its spring-loaded state, and interlock mechanism 88 is reset into its locked state while latch mechanism 52 remains in its unlatched state. Thereafter, latch mechanism 52 can be shifted back into its latched state due to engagement of striker 20 with ratchet 56 causing ratchet 56 to pivot to its striker capture position whereat pawl 62 can move from its ratchet releasing position to its ratchet holding position under the biasing influence of pawl spring 66 in response to closing of passenger door 16. In a power release application the signal to initiate the power reset operation can be accomplished various ways. In one illustrative manner, a “reset” signal based on the detected position of release cam 90 in its pawl release position is used by a latch controller (not shown) to initiate the power reset operation while a “home” signal based on the detected position of release cam 90 in its home position is used to complete the power reset operation. In other illustrative manners, a “reset signal” can be sent by the closure latch assembly 18, door 16, or vehicle controller (not shown) upon detecting the release cam 90 position (via a switch or sensor, both not shown but provided as part of the closure latch assembly 18), or upon detecting pawl 62 position (via a switch or sensor, both not shown but provided as part of the closure latch assembly 18), or also upon detecting a door open signal from a switch or sensor (both not shown but provided as part of the closure latch assembly 18) associated with the ratchet 56, or also upon detecting a door ajar signal detected by a sensor or switch associated with a pillar (e.g. on edge portion 14A, or other location) or a door mounted (e.g. on edge portion 16A, or other portion of the door 16) door ajar switch (not shown) that is not provided as part of the closure latch assembly 18. In a cinch application the controller (not shown) may be in communication with a sensor or switch on the pawl 62 and/or a sensor on the ratchet 56 to determine if the door 16 is fully closed and initiate the power reset operation.

The present disclosure is particularly well-suited for “reverse-driven” power actuators using a bi-directional function to provide a mechanism “actuation” function and a subsequent mechanism “reset” function. While spring-assist mechanism 86 is shown in association with latch release mechanism 80 for providing a power release function, it is to be understood that a similar spring-assist mechanism can be easily adapted for use with a power cinch actuator to provide a “spring assist” function for driving a latch cinch mechanism in cooperation with the electric motor to mechanically move ratchet 56 of latch mechanism 52 from a secondary striker capture position (i.e. door 16 latched in a secondary or “soft-closed” position) into a primary striker capture position (i.e. door 16 latched in a primary or hard-closed position), thereby providing a power cinch function. Ratchet 56 would, in such a configuration, include a pair of latch notches comprised of a secondary latch notch engageable with pawl latch tooth to hold ratchet 56 in its secondary striker capture position and a primary latch notch engageable with pawl latch tooth in its primary striker capture position. In such an arrangement, the latch mechanism would define an unlatched state (ratchet in its striker release position), a secondary latched state (ratchet held in its secondary striker capture position), and a primary latched state (ratchet held in its primary striker capture position). Actuation of the electric motor in the actuation direction would function to cause the latch cinch mechanism to shift from its non-actuated state into its actuated state for moving ratchet 56 from its secondary striker capture position into its primary striker capture position with the assistance of the biasing from the assist spring. Upon completion of the power cinch operation, actuation of the electric motor in the reset direction would function to reset the latch cinch mechanism into its non-actuated state while reloading the assist spring. Resetting of the latch cinch mechanism into its non-actuated state permits subsequent release of latch mechanism 52. Obviously, closure latch assembly 18 can be equipped with either or both of these spring-assisted power actuators. For example, and with reference to Patent Application Publication number U.S. 2018/0100331 entitled “Power Closure Latch Assembly With Cinch Mechanism Having Ratchet Retention Function” (hereinafter referred to as the “'331 Application”), the entire disclosure of which is incorporated herein by reference wherein reference numerals described therein are referenced herein yet offset by a factor denoted by the prime symbol “′”, the power cinch actuator 38′ of the '331 Application may be adapted with the teachings of the present disclosure such that the actuation of the power cinch actuator 38′ in the reset direction would function to reset the latch cinch mechanism 34′ into its non-actuated state while reloading the assist spring adapted to assist the power cinch actuator 38′ with actuating latch cinch mechanism 34′. As another example, power cinch disengage actuator 42′ of the '331 Application may also be adapted with the teachings of the present disclosure. For example, and with reference to Patent Application Publication number U.S. 2018/0051502 entitled “Power Door Presenter With Latching Feature” (hereinafter referred to as the “'502 Application”), the entire disclosure of which is incorporated herein by reference wherein reference numerals described therein are referenced herein yet offset by a factor denoted by the double prime symbol “″”, the motor-driven mechanism 412″ of the '502 Application may be adapted with the teachings of the present disclosure such that the actuation of the electric motor 414″ in the reset direction causing return to its home position would function to return extensible member 421″ to its retracted position while reloading the assist spring adapted to assist the electric motor 414″ with moving the extensible member 421″ to a deployed position. It is to be understood that a similar spring-assist mechanism in accordance with the teachings herein can be easily adapted for use with a power lock/unlock actuator to provide a “spring assist” function for driving a lock/unlock mechanism. Thus, the present disclosure employs a biasing device or arrangement which complements the energy of the electric motor applied to selectively actuate an “actuatable” mechanism associated with closure latch assembly 18. An enhanced power actuator for closure latch assembly 18 is disclosed for use with a power release function, a power cinching function, a combined power release and power cinching function, and/or to any three (3) position actuator which requires the electric motor to be reverse driven to reset the actuatable mechanism. Accordingly, the spring-assist mechanism of the present disclosure uses an assist spring to store and release energy to assist in actuating the actuatable mechanism. The assist spring is reloaded with stored energy upon powered resetting of the actuatable mechanism. Thus, the energy of the electric motor, as it is reversibly driven, is used to load the assist spring while the interlock mechanism is used to hold the stored energy until subsequently released during powered actuation of the actuatable mechanism. As a result, the size of the electric motor can be reduced since less energy is required from the motor to actuate the actuatable mechanism. A smaller motor results in a closure latch assembly with reduced weight, power consumption, and cost. Moreover, existing closure latch assemblies with power release and/or power cinching functionality can be easily modified to incorporate this spring assist functionality and, for example, without having to alter the strength module and/or the striker height of the closure latch assembly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a closure panel of a motor vehicle closure system, comprising:
a latch mechanism operable in a latched state to hold the closure panel in a closed position and in an unlatched state to permit movement of the closure panel toward an open position; and
a power release actuator including a latch release mechanism, an electric motor, a spring-assist mechanism, and an interlock mechanism, the latch release mechanism being operable in a non-actuated state to permit the latch mechanism to operate in its latched state and in an actuated state to shift the latch mechanism from its latched state into its unlatched state, the electric motor being operably driven in an actuation direction for causing the latch release mechanism to shift from its non-actuated state into its actuated state and operably driven in a reset direction for causing the latch release mechanism to shift from its actuated state into its non-actuated state, the spring-assist mechanism being operable in a spring-loaded state when the latch release mechanism is operating in its non-actuated state and operable in a spring-released state when the latch release mechanism is shifted into its actuated state, the interlock mechanism being operable in a locked state to hold the spring-assist mechanism in its spring-loaded state and in a released state to cause the spring-assist mechanism to shift into its spring-released state,
wherein the spring-assist mechanism is operable in its spring-released state to exert a spring-assist force on the latch release mechanism which functions in cooperation with rotation of the electric motor in the actuation direction to drive the latch mechanism to its unlatched state for providing a spring-assisted power release function.

2. The closure latch assembly of claim 1, wherein a power release signal provided to a latch controller is used to initiate the spring-assisted power release function and cause the electric motor to be driven in the actuation direction for causing the latch release mechanism to shift into its actuated state and cause the interlock mechanism to shift into its released state, whereby the spring-assist mechanism is shifted into its spring-released state and applies the spring-assist force to the latch release mechanism to assist the latch release mechanism in shifting the latch mechanism into its unlatched state.

3. The closure latch assembly of claim 2, wherein a power reset function is initiated upon completion of the spring-assisted power release function.

4. The closure latch assembly of claim 3, wherein a power reset signal is provided to the latch controller to initiate rotation of the electric motor in the reset direction which causes the latch release mechanism to be returned to its non-actuated state, the spring-assist mechanism to be returned to its spring-loaded state, and the interlock mechanism to be returned to its locked state.

5. The closure latch assembly of claim 4, wherein upon completion of the power reset function the latch mechanism can be returned to its latched state in response to movement of the closure panel to its closed position.

6. The closure latch assembly of claim 1, wherein the latch mechanism includes a ratchet and a pawl, the ratchet being moveable between a striker release position whereat a striker fixed to a vehicle body is displaced from engagement with the ratchet and a striker capture position whereat the ratchet retains and holds the striker, the ratchet being biased toward its striker release position, the pawl being moveable between a ratchet releasing position whereat the ratchet is permitted to move toward its striker release position and a ratchet holding position whereat the pawl holds the ratchet in its striker capture position, the pawl being biased toward its ratchet holding position, the latch mechanism is operating in its unlatched state when the ratchet is located in its striker release position and is operating in its latched state when the ratchet is held in its striker capture position,
wherein the latch release mechanism includes a release cam rotatably driven by the electric motor between a home position whereat the pawl is permitted to move between its ratchet releasing and ratchet holding position and a pawl release position for moving the pawl to its ratchet releasing position, the latch release mechanism is operating in its non-actuated state when the release cam is located in its home position and is operating in its actuated state when the release cam is located in its pawl release position,
wherein movement of the release cam from its home position to its pawl release position is caused by rotation of the electric motor in the actuation direction for providing the spring-assisted power release function, and movement of the release cam from its pawl release position to its home position is caused by rotation of the electric motor in the reset direction for providing a power reset function.

7. The closure latch assembly of claim 6, wherein the spring-assist mechanism includes an assist lever and an assist lever spring, the assist lever is moveable between a spring-loaded position and a spring-released position in response to movement of the release cam between its home and pawl release positions, the assist lever being located in its spring-loaded position when the release cam is located in its home position and is located in its spring-released position when the release cam is located in its pawl release position, the assist lever spring biasing the assist lever toward its spring-released position, the assist lever spring being loaded when the assist lever is held in its spring-loaded position and the assist lever spring being released to apply the spring-assist force to the release cam when the assist lever is permitted to move to its spring-released position, the spring-assist mechanism being operable in its spring-loaded state when the assist lever is located in its spring-loaded position and is operable in its spring-released state when the assist lever is located in its spring-released position.

8. The closure latch assembly of claim 7, wherein the interlock mechanism includes an interlock lever operable in a locked position to hold the assist lever in its spring-loaded position and operable in a released position to release the assist lever for movement toward the assist lever for movement toward its spring-released position, the interlock mechanism operating in its locked state when the interlock lever is located in its locked position and operating in its released state when the interlock lever is located in its released position.

9. The closure latch assembly of claim 8, wherein movement of the release cam between its home and pawl release position causes corresponding movement of the interlock lever between its locked and released positions.

10. A closure latch assembly for a closure panel of a motor vehicle closure system, comprising:
a latch mechanism operable in an unlatched state when the closure panel is in an open position, a secondary latched state to hold the closure panel in a partially-closed position, and in a primary latched state to hold the closure panel in a fully-closed position; and
a power cinch actuator for providing a spring-assisted power cinch function operable to shift the latch mechanism from its secondary latched state into its primary latched state, the power cinch actuator including a latch cinch mechanism, an electric motor, a spring-assist mechanism, and an interlock mechanism, the latch cinch mechanism being operable in a non-actuated state when the latch mechanism is in its primary latched state and in an actuated state to shift the latch mechanism from its secondary latched state into its primary latched state, the electric motor being operably driven in an actuation direction for causing the latch cinch mechanism to shift from its non-actuated state into its actuated state and operably driven in a reset direction for causing the latch cinch mechanism to shift from its actuated state into its non-actuated state, the spring-assist mechanism being operable in a spring-loaded state when the latch cinch mechanism is in its non-actuated state and being operable in a spring-released state when the latch cinch mechanism is shifted into its actuated state, the interlock mechanism being operable in a locked state to hold the spring-assist mechanism in its spring-loaded state and in a released state to cause the spring-assist mechanism to shift into its spring-released state,
wherein the spring-assist mechanism is operable in its spring-released state to exert a spring-assist force on the latch cinch mechanism which functions in cooperation with the electric motor to drive the latch mechanism to its primary latched state.

11. The closure latch assembly of claim 10, wherein a power cinch signal is provided to a latch controller when the closure panel is located in its partially-closed position and is used to initiate the spring-assisted power cinch function and cause the electric motor to be driven in the actuation direction for causing the latch cinch mechanism to shift into its actuated state and cause the interlock mechanism to shift into its released state, whereby the spring-assist mechanism is shifted into its spring-released state and applies the spring-assist force to the latch cinch mechanism to assist the electric motor in shifting the latch mechanism from its secondary latched state into its primary latched state.

12. The closure latch assembly of claim 11, wherein a power reset function is initiated upon completion of the spring-assisted power cinch function.

13. The closure latch assembly of claim 12, wherein a power reset signal is provided to the latch controller to initiate rotation of the electric motor in the reset direction which causes the latch cinch mechanism to be returned to its non-actuated state, the spring-assist mechanism to be returned to its spring-loaded state, and the interlock mechanism to be returned to its locked state.

14. The closure latch assembly of claim 10, further comprising a latch release mechanism operable to shift the latch mechanism from either of its secondary and primary latched states into its unlatched states.

15. A closure latch assembly for a closure panel of a motor vehicle closure system, comprising:
a latch mechanism operable in a first state to hold the closure panel in a first position and in a second state to locate the closure panel in a second position; and
a power actuator including an actuatable mechanism, an electric motor, a spring-assist mechanism, and an interlock mechanism, the actuatable mechanism being operable in a non-actuated state to permit the latch mechanism to operate in its first state and in an actuated state to shift the latch mechanism from its first state into its second state, the electric motor being operably driven in an actuation direction for causing the actuatable mechanism to shift from its non-actuated state into its actuated state and being operably driven in a reset direction for causing the actuatable mechanism to shift from its actuated state into its non-actuated state, the spring-assist mechanism being operable in a spring-loaded state when the actuatable mechanism is operating in its non-actuated state and being operable in a spring-released state when the actuatable mechanism is shifted into its actuated state, the interlock mechanism being operable in a locked state to hold the spring-assist mechanism in its spring-loaded state and in a released state to cause the spring-assist mechanism to shift into its spring-released state,
wherein the spring-assist mechanism is operable in its spring-released state to exert a spring-assist force on the actuatable mechanism which functions in cooperation with rotation of the electric motor in the actuation direction to drive the latch mechanism to its second state for providing a spring-assisted power actuation function.

16. The closure latch assembly of claim 15, wherein the actuatable mechanism is a latch release mechanism operable in its non-actuated state to maintain the latch mechanism in either of its first (latched) state and its second (unlatched) state and is operable in its actuated state to shift the latch mechanism from its latched state into its unlatched state, wherein the latch mechanism is also operable in its latched state to hold the closure panel in its first (closed) position and is operable in its unlatched state to permit movement of the closure panel to its second (open) position, and wherein the shifting of the spring-assist mechanism into its spring-released state results in the spring-assist force being exerted on the latch release mechanism for assisting the electric motor in driving the latch mechanism to its unlatched state to provide a power release function.

17. The closure latch assembly of claim 16, wherein the latch mechanism includes a ratchet and a pawl, the ratchet being moveable between a striker release position whereat a striker fixed to a vehicle body is displaced from engagement with the ratchet and a striker capture position whereat the ratchet retains and holds the striker, the ratchet being biased toward its striker release position, the pawl being moveable between a ratchet releasing position whereat the ratchet is permitted to move toward its striker release position and a ratchet holding position whereat the pawl holds the ratchet in its striker capture position, the pawl being biased toward its ratchet holding position, the latch mechanism is operating in its unlatched state when the ratchet is located in its striker release position and is operating in its latched state when the ratchet is held in its striker capture position,
wherein the latch release mechanism includes a release cam rotatably driven by the electric motor between a home position whereat the pawl is permitted to move between its ratchet releasing and ratchet holding position and a pawl release position for moving the pawl to its ratchet releasing position, the latch release mechanism is operating in its non-actuated state when the release cam is located in its home position and is operating in its actuated state when the release cam is located in its pawl release position,
wherein movement of the release cam from its home position to its pawl release position is caused by rotation of the electric motor in the actuation direction for providing the power release function, and movement of the release cam from its pawl release position to its home position is caused by rotation of the electric motor in the reset direction for providing a power reset function.

18. The closure latch assembly of claim 17, wherein the spring-assist mechanism includes an assist lever and an assist lever spring, the assist lever is moveable between a spring-loaded position and a spring-released position in response to movement of the release cam between its home and pawl release positions, the assist lever being located in its spring-loaded position when the release cam is located in its home position and is located in its spring-released position when the release cam is located in its pawl release position, the assist lever spring biasing the assist lever toward its spring-released position, the assist lever spring being loaded when the assist lever is held in its spring-loaded position and the assist lever spring being released to apply the spring-assist force to the release cam when the assist lever is permitted to move to its spring-released position, the spring-assist mechanism being operable in its spring-loaded state when the assist lever is located in its spring-loaded position and is operable in its spring-released state when the assist lever is located in its spring-released position.

19. The closure latch assembly of claim 18, wherein the interlock mechanism includes an interlock lever operable in a locked position to hold the assist lever in its spring-loaded position and operable in a released position to release the assist lever for movement toward the assist lever for movement toward its spring-released position, the interlock mechanism operating in its locked state when the interlock lever is located in its locked position and operating in its released state when the interlock lever is located in its released position.

20. The closure latch assembly of claim 15, wherein the actuatable mechanism is a latch cinch mechanism operable in its non-actuated state when the latch mechanism is operating in its first (secondary latched) state for holding the closure panel in its first (partially-closed) position, wherein the latch cinch mechanism is also operable in its actuated state to shift the latch mechanism from its secondary latched state into its second (primary latched) state for moving the closure panel from its partially-closed position to its second (fully-closed) position, and wherein the shifting of the spring-assist mechanism into its spring-released state results in the spring-assist force being applied to the latch cinch mechanism for assisting the electric motor in driving the latch mechanism to its primary latched state to provide a power cinching feature.
